(19) United States
(12) Patent Application Publication
(10) Pub. No.: US 2008/0175681 A1
(43) Pub. Date: Jul. 24, 2008

(54) HARDWOOD FLOORING INSTALLATION SYSTEM AND METHOD

(76) Inventor: Ehtesham Tataei, Dickerson, MD (US)

Correspondence Address: BERENATO, WHITE & STAVISH, LLC, 6550 ROCK SPRING DRIVE, SUITE 240, BETHESDA, MD, 20817, US

(21) Appl. No.: 12/023,510

(22) Filed: Jan. 31, 2008

Related U.S. Application Data
(63) Continuation-in-part of application No. 11/650,583, filed on Jan. 8, 2007.
Application No. 11/650,583 is a continuation-in-part of application No. 10/816,833, filed on Apr. 5, 2004.

(51) Int. Cl. B23B 49/00; B23B 39/22; B23B 39/02

(52) U.S. Cl. 408/16; 408/87; 408/37

(57) ABSTRACT

A floor installation system includes a hole making device for drilling holes in a solid wood strip. The hole making device comprises a linear guide assembly including at least one guiding rod, a first drill motor slidably mounted on the guiding rod of the linear guide assembly, a first fixed wood guiding sidewall non-movably mounted to the linear guide assembly and a second wood guiding sidewall mounted to the linear guide assembly. The first drill motor is provided with a first drill chuck driven by the first drill motor for drilling a hole in the solid wood strip. The first and second wood guiding sidewalls define a wood guiding channel therebetween for supporting the solid wood strip. The hole making further comprises an actuator motor provided for selectively moving the first drill motor along the guiding rod to and away from the wood guiding channel.

### CROSS-REFERENCE TO RELATED APPLICATIONS

This application is a Continuation-in-Part (CIP) of U.S. patent application Ser. No. 11/650,583, filed Jan. 8, 2007, which is a Continuation-in-Part (CIP) of U.S. patent application Ser. No. 10/816,833 filed Apr. 5, 2004, both of which are incorporated herein by reference in their entirety.

### BACKGROUND OF THE INVENTION

1. Field of the Invention

The present invention relates to floor installation systems, and more particularly to a floor installation system including a hole making device for drilling holes in a solid wood strip.

2. Description of the Prior Art

Typically, flooring systems (e.g., hardwood floors) are made of different species of wood coming from different kinds of trees in nature such as oak, walnut, hickory, maple, and cherry just to name a few. They are all manufactured in random lengths from 18 inches up to 60 inches long and also random widths, which can vary from 2¼, 3, 3¼, 4, 5, 6 up to 7 inches wide. All hardwood floors, however, do have one thing in common which is their tongue-and-groove interlocking arrangement. Every piece of hardwood flooring has a single groove on one lengthwise side and one tongue on the opposite lengthwise side that allows the tongue of one piece to sit in the groove of the neighboring piece.

There are two different categories of hardwood floors, solid and engineered. The one category made with ¾″ thickness from solid wood is called “solid hardwood floors,” and the other category made out of pressed three ply with a veneer of wood attached to their top surfaces is called “engineered hardwood floors” and their thickness typically varies from ⅜ inches up to 9/16^{th} of an inch. FIG. 1 illustrates the referenced dimensions of length, thickness and width for a hardwood floor board.

There are mainly two methods that could be used to install hardwood on a surface. The first method is called nail down, and the second method is called glue down. In the United States and for that matter most of the countries around the globe, most commercial floors and residential basement floors are made of concrete, whereas the first and second floors of residential houses and townhouses are made out of wooden frame covered with plywood underlie.

Up to now the solid wood has only been used to cover the first and second floors of residential houses and townhouses as only the plywood underlie flooring allows the use of the nail down method, thus we see the solid hardwood floor is restricted in its market. Solid hardwood can not be nailed down to floors made out of concrete and also can not be glued to them first because of their solidity and their thickness and second because of their extreme measure of expansion and contraction due to atmospheric temperature and moisture degree change. For this reason, the hardwood industry came up with the second alternative called engineered hardwood floors. This type of hardwood floor is glued down to concrete floors using second method, which is the glue down method.

In the course of the last two decades the hard surface industry has also invented laminate flooring, which is a type of “floating” floor system made out of pressed composite wood covered by a decorative layer of imitation laminated wood veneer.

So far, however, no other floor covering product has replaced the durability and beauty of real solid hardwood. Engineered hardwood is very deficient. For example, when this type of wood is installed, the trapped moisture that may be present inside of concrete elevates to the wood and makes the wood susceptible to bowing, warping and separation of the wood from the concrete underneath. Another problem with this kind of engineered wood is temperature change. When temperature fluctuates the wood starts expanding or contracting and this also results in separation of wood from concrete and appearance of gaps between the wood planks.

Another deficiency of this engineered wood is its lifetime. Once installed, the engineered wood goes through wear and tear and scratches and it must be taken up and disposed of, as it cannot be sanded and refinished for reuse. For these reasons the commercial industry is hesitant to buy, install and invest in engineered hardwood flooring.

The cost of producing engineered hardwood floor is equal to or sometimes much higher than the cost of producing solid hardwood floors. In comparison, solid hardwood flooring is a beautiful product that can be sanded and finished over and over so it may last for a few decades without replacement.

The need therefore exists for a hardwood installation system and method that overcomes the drawbacks inherent in the prior art.

### SUMMARY OF THE INVENTION

The invention is s floor installation system that includes a hole making device for drilling bore holes in a solid wood strip. The hole making device, in turn, comprises a linear guide assembly including at least one guiding rod, a first drill motor slidably mounted on the at least one guiding rod of the linear guide assembly, a first fixed wood guiding sidewall non-movably mounted to the linear guide assembly and a second wood guiding sidewall mounted to the linear guide assembly. The first drill motor is provided with a first drill chuck driven by the first drill motor for drilling a hole in the solid wood strip. The first and second wood guiding sidewalls define a wood guiding channel therebetween for supporting the solid wood strip. The hole making further comprises an actuator motor provided for selectively moving the first drill motor along the at least one guiding rod of the linear guide assembly to and away from the wood guiding channel.

### BRIEF DESCRIPTION OF THE DRAWINGS

Objects and advantages of the invention will become apparent from a study of the following specification when viewed in light of the accompanying drawings, wherein:

FIG. 1 shows a typical hardwood floor board.

FIG. 2 illustrates an example of the hole making device in accordance with a first exemplary embodiment of the present invention.

FIG. 3 illustrates the head portion of the hole making device of FIG. 2.

FIG. 4 illustrates the body portion of the hole making device of FIG. 2.

FIG. 5 illustrates a sliding drill head complex.

FIG. 6 illustrates a drill machine holder complex.

FIGS. 7a and 7b illustrate the main fastener member of this invention in accordance with the first exemplary embodiment of the present invention.

FIG. 8 illustrates a length adjuster screw used in situations where board is trimmed partially and its width is shortened.

FIG. 9 illustrates a resilient washer member.

FIG. 10 illustrates an adjust/reverse fastener according to this invention.

FIG. 11 illustrates a female nut member according to this invention.

FIG. 12 illustrates a synchro nut and synchro o-ring according to this invention.

FIG. 13 illustrates a finishing end cap nut according to this invention.

FIG. 14 illustrates a solid metal washer used for adjustment by filling spaces between fasteners where the fasteners are loose.

FIG. 15 illustrates a depth measuring nut 99 used to measure the depth of a fastener to be added to the total length of a length adjuster screw in order to match the correct sizes.

FIG. 16 illustrates a synchronizer used in conjunction with the synchro nut and synchro o-ring of FIG. 12.

FIGS. 17a and 17b illustrate a type of male and female cross-transition lock screws used when there is a need for a transitional piece to be installed perpendicular to the direction of a particular wood strip.

FIG. 18 exemplifies one example of the interlocking system according to this invention.

FIG. 19 illustrates the methodology for using this installation system when a floor board is ripped or cut lengthwise to fit a narrow area.

FIG. 20 illustrates the starting lock nut with a hexagonal head shown in partial cross section.

FIG. 21 illustrates an example of the hole making device in accordance with a second exemplary embodiment of the present invention.

FIG. 22 illustrates a fastener member in accordance with the second exemplary embodiment of the present invention.

FIG. 23 illustrates an example of the hole making device in accordance with a third exemplary embodiment of the present invention.

### DETAILED DESCRIPTION OF PREFERRED EMBODIMENTS

The preferred embodiments of the present invention will now be described with the reference to accompanying drawings.

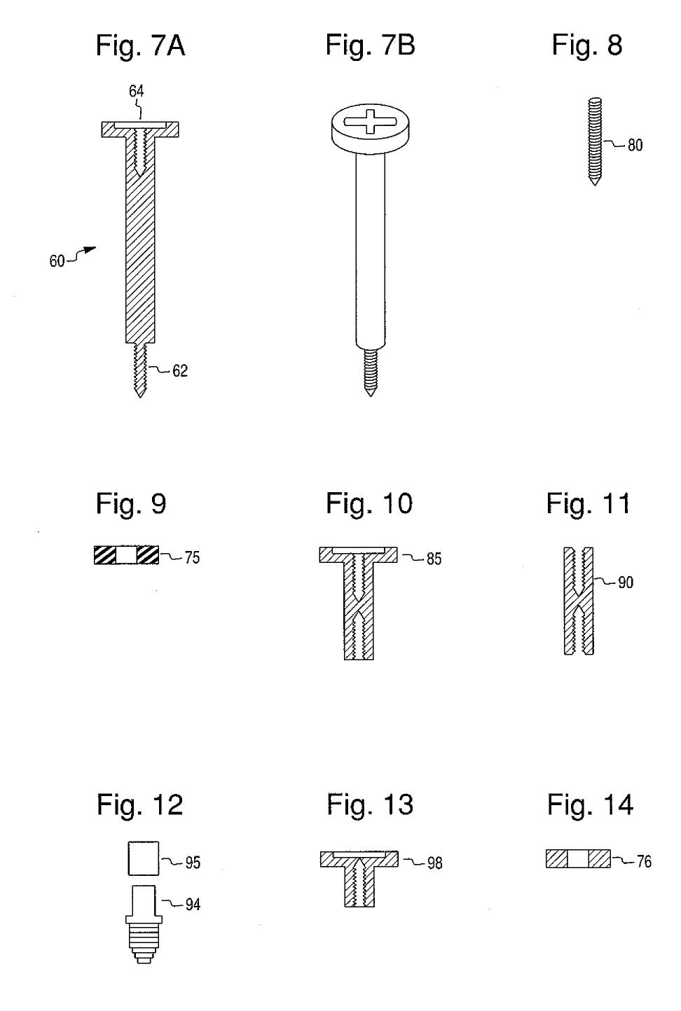

This invention primarily in accordance with a first exemplary embodiment of the present invention comprises a hole making device generally depicted with the reference numeral 10, and a series of fasteners and their components. The hole making device 10 is designed to make cross sectional bore holes in the body of the solid hardwood strips 1, allowing the fasteners to be seated in the referenced holes. The cross sectional bore holes pass through the strip 1 and are formed with an enlarged entrance portion to receive an enlarged head of the fastener 60 shown in FIGS. 7a-7b. The hole making device 10 is equipped with a measuring tool 12 which allows the precise measurement of distance between two neighboring holes.

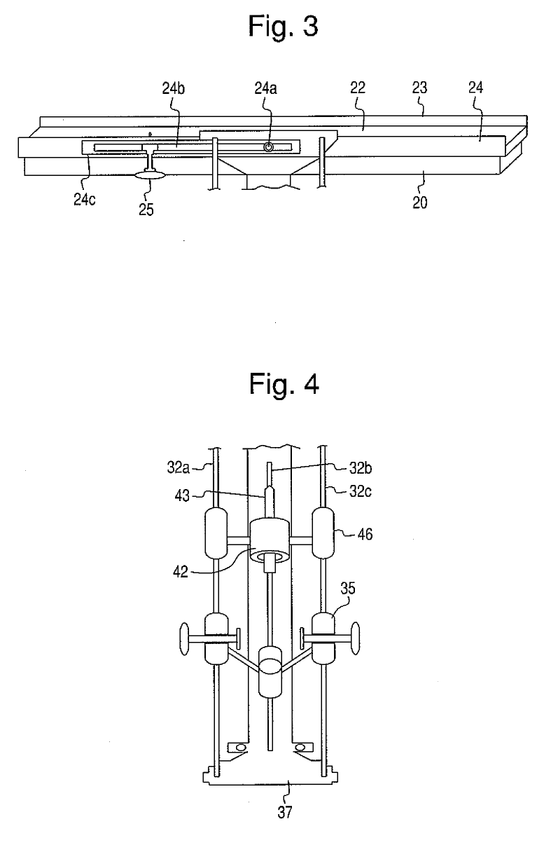

In the preferred embodiment shown in FIG. 2, the hole making device 10 is formed as a T-shaped assembly. The head 20 of the T-shaped assembly as shown in FIG. 3 is designed in the form of a channel 22. The right side wall 23 of the channel 22 is adjustable to accommodate incoming hardwood strips with different widths. The left sidewall 24 of the channel 22 contains a central hole 24a, an elongated side window 24b and a windowed ruler 24c attached to the left side wall 24 from the outside. The ruler 24c has a window that matches the side window 24b of the left sidewall 24. Built over the wall window 24b, the zero of the ruler 24c precisely coincides with the central hole 24a on the left sidewall 24. The ruler 24c also is equipped with a sliding pointer 25 which slides inside the ruler's window and shows wherever the pointer's head coincides with any number on the ruler that indicates the distance of the first hole made in the body of the wood and the second hole being made at zero of the ruler which is the central hole.

The pointer 25 may be provided with a screw nut bracket, which tightens the pointer 25 at the desired point on the ruler 24c. The pointer bracket also has a spring-loaded handle, the tail of which is a long passing pin, which passes through the side window and the first hole made in the wood. This tail acts like a locking device, avoiding the wood and the first hole to move forward and backward while the next hole is made at the central hole. When the handle is released the wood is allowed to move forward, and, since the handle is spring loaded this time the pointer's pin will engage in the second hole, and this gives way to the third hole to be made at the central hole and so on.

The body 30 of the hole making device 10 provides a mounting structure for the drilling components of the hole making device 10. The mounting structure comprises rails in the form of three stainless steel rods 32a, 32b, 32c mounted to two triangular support members 34, 35 at their vortexes. The rails 32a-32c and support members 34, 35 are mounted to an adjustable support plate 37 whose height relative to the head 20 is adjustable.

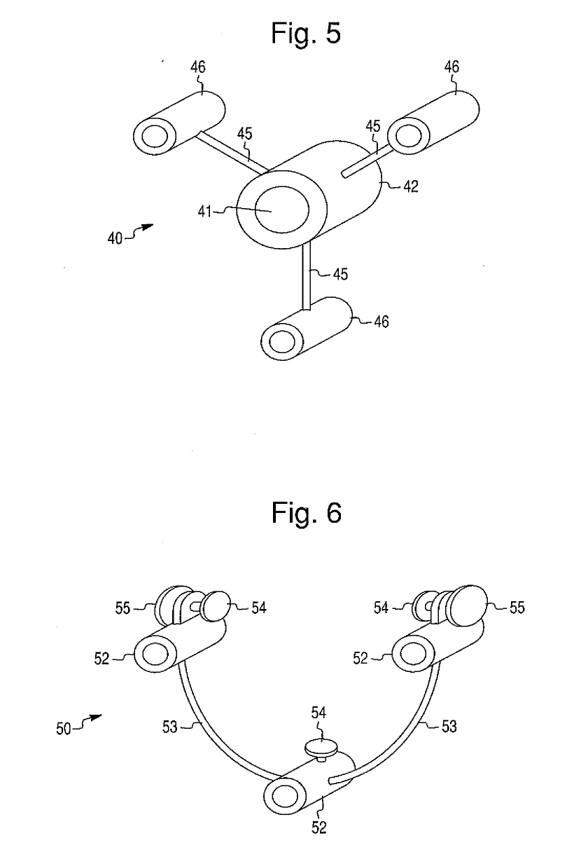

The drilling components will now be described. With reference to FIG. 5, a sliding drill head complex 40 which has an inner cone headed cylinder 41, and which is capable of being spun, acting like a drill head holds a two stage drill bead 43 and sits inside an outer non spinning cylinder 42. Three connection bars 45 welded to the outer non spinning cylinder 42 are positioned 120 degrees on the outer rim of the cylinder holding three sliding cylinders 46 at their other ends. When this complex is assembled, three stainless steel rods 32a-32c pass through the three sliding cylinders 46 and the complex slides forward and backward on the rods 32a-32c.

With reference to FIG. 6, an adjustable drill holder complex 50, which contains three sliding cylinders 52, is connected by two bowing hands 53 that link the cylinders 52 from two sides. The hands 53 position the three cylinders 52 at symmetrical 120 degrees from each other. To each cylinder 52, a bracket 54 is welded which is equipped with a turning knob 55 connected to a cushioned end enabling the complex to adjust and grip different types of drill machines (see element‘d’ of FIG. 2). When assembled, the three stainless steel rods also pass through the sliding cylinders 52 and the holder complex 50 is positioned behind the drill head complex 40 on the rods, sliding freely forward and backward to adjust to any drill machine's body leverage.

While the hole making device 10 has been shown and described with respect to the best mode of this invention, it will be understood that the hole maker may function like a typical drill press or other assembly designed to form lateral holes in the wood member at desired positions.

The fasteners and their components will now be described with reference to FIGS. 7a-17b. The fasteners and their components are designed to fasten the hardwood strips in a very versatile and practical way so that any type of floor can be covered by solid hardwood.

The main fastener 60 is primarily used to fasten the strips of wood together and is designed in different lengths to accommodate, for example, 3″, 3¼″, 4″, 5″ and 6″ widths. As shown in FIGS. 7a and 7b, the main fastener 60 is designed as a screw member with a male end 62 and a female end 64 such that the male end 62 may be matingly received in the female end 64. The female end 64 is also preferably formed to receive a flat-end or Phillips-end screwdriver or other torque device.

In its most simple incarnation, the present invention utilizes the main fasteners 60 to interlock adjacent boards 1, 2 whereby a first series of main fasteners 60′ are disposed in the first series of boards 1 with a starting lock nut 70 threaded onto the male end 62′. The starting lock nut 70 has a hexagonal head as shown in FIG. 20. A resilient, flexible washer 75 (see FIG. 9) made, preferably, of soft plastic adjusts the tension between wood and the fasteners when the wood expands or contracts. The second series of boards 2 are then aligned with the first series of boards 1 so that the male end 62″ of the main fasteners 60″ are threadingly received in the female end 64′ of the fasteners 60′. This process is continues throughout the installation area.

As will be understood by those of skill in the art, installation usually requires certain boards to be trimmed or notched to fit the installation area. A special length adjuster screw 80 shown in FIG. 8 may be used in situations where board is trimmed partially and its width is shortened, as this part can be clipped and shortened to accommodate for variable width adjustment. An adjusting/reversing fastener 85 is used with the length adjuster screw 80, the adjuster screw 80 and fastener 85 together function much like the main fastener 60.

As described below, the adjusting/reversing fastener 85 can also be used to reverse the installation direction.

Similarly, the present invention also comprises a female nut member 90 which converts the end of the main fastener 60 to a female joint. The female nut member 90 is especially useful when an additional hardwood area is added to an existing hardwood area.

As shown in FIGS. 13a and 13b, a synchronizing nut 94 and a synchronizing o-ring 95 are used in areas where wood strips are joined perpendicular to one another. The nut 94 and o-ring 95 prevent vertical and horizontal movement at the joint. The synchro nut 94 is screwed into one of the boards and the synchro o-ring 95 is disposed in the adjacent board such that the synchro nut 94 is received in the o-ring 95. A synchronizer or marker 100 may be used to mark the alignment of the synchro nut 94 and synchro O-ring 95 on two parallel wood strips. The synchro nut 94 and synchro O-ring 95 are inserted at the intersection of the two wood strips. The location of drilling these two areas is created point-to-point. The synchronizer or marker 100 provides the exact point-to-point marking locations on both pieces of wood to be drilled for insertion of the nut 94 and O-ring 95.

A finishing end cap nut 98 combines with the length adjuster screw 80, whereby the end cap nut 98 caps and finishes the last piece of hardwood board at the finishing wall.

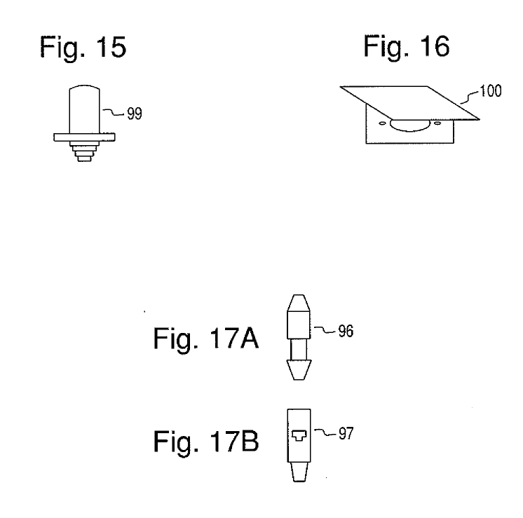

A solid metal washer 76 such as illustrated in FIG. 14 may be used for adjustment by filling spaces between fasteners where the fasteners are loose. In addition, a depth measuring nut 99 such as shown in FIG. 15 may be used to measure the depth of a fastener to be added to the total length of a length adjuster screw 80 in order to match the correct sizes.

When there is a need for a transitional piece to be installed perpendicular to the direction of a particular wood strip, male and female cross-transition lock screws 96, 97 shown in FIGS. 17a and 17b provide the mechanical connectors capable of performing the connection.

There are several suggested rules to be employed when starting the installation process utilizing the present invention:

1. The hole making direction is preferably left to right.

2. The drilling direction is preferably from the groove to the tongue.

3. The first strip of each row is drilled 4 inches to the right from left end of the strip.

4. When the first hole is made at 4 inches the second hole can be drilled 8 to 12 inches from it, and when this distance is set it must remain the same through out the rest of the installation process. For example, if this distance is set on an 8 inch increment, the rest of the holes will follow 8 inches from each other, except the first hole of every new row which is set back to 4 inches. The number of fasteners needed in a given area can be calculated by dividing the length of the area, which is equal to the length of one row in this increment multiplied by width of the area divided by width of the wood strip. In a 10 foot by 10 foot room, 120 inches—length of area/8 inch increment and 120 inches width of the area/3 inch width of each wood strip=600 fasteners needed, although if the increment is set on 10 inches then 480 fasteners are needed.

5. In order to keep the precise distance between the holes in every row and synchronize the holes of the neighboring rows: A—Every strip of wood must be inserted in the hole maker device one after another and when the final hole in the first wood strip is created, the second wood strip comes in and joins the first wood strip tightly, and right after the first hole in the second wood strip is created the first wood strip can exit out for installation. B—due to the size difference in the wood strips' length, the strips cannot be advanced or be left out in the installation process. The strips come out of the hole maker and in the same sequence they get installed. The first wood strip gets installed and then the second, the third and so on.

The installation process utilizing the instant invention will now be described with reference to the foregoing hole making apparatus and a series of fasteners and their components.

After the wood flooring is acclimated and the floor area is prepared, it will get covered with one layer of poly flex foam, which is a rolled product. The next step is to choose a starting wall. It is always a good idea to choose a wall which has a door way or it needs a transitional piece because at this stage this piece can be attached to the wood strips easily and efficiently. When the wall is chosen the hole making process can be started. A regular drill machine is needed to be attached to the hole making device 10 in a way that the drill head is tightened when engaged with the spin tail of the sliding drill head complex 40, the body of the drill machine will fall in the adjustable drill holder complex 50 which now can be adjusted and tightened to the drill machine by tightening its knobs 55. The hole making device 10 is designed and equipped with a ruler 24c and sliding pointer 25 which measures the precise distance between two holes. Every hole is made at zero mark on the ruler which is the central hole of the T channel where the drill bead intercepts with the wood strip's groove, and as the first hole must be made 4 inches from the left end of the strip, we set the ruler's sliding pointer at the 4 inch mark by sliding and tightening it at that point. When the wood is inserted into the T head channel 22, width adjustment can be made by sliding the adjustable wall 23 of the channel 22 towards wood and tightening the knobs on the back of the side wall 23. When we slide the wood strip more into the T head channel the tail of the ruler's sliding pointer stops the wood. At this time, if we slide the drill towards the central hole and create a hole it will be exactly placed 4 inches from the left end of the wood strip. When the first hole is made we set the sliding pointer of the ruler on 8, 9, 10, 11 or 12 inches or any desirable distance. For instance if an 8 inch increment is chosen it has to stay at the same interval during the entire installation process except the first hole on every new row which the number is set back to 4 inches.

A resilient plastic washer 75 is combined with every fastener 60 to accommodate enough space for wood expansion and contraction. One fastener and washer combo 60, 75 is inserted in every wood strip hole.

Setting and installing the first row of wood strip at the starting wall is the most crucial part of the process. At this time ½ inch of distance must be kept between the wall and the first row of the strips. In order to secure the fasteners inserted into the bores of the first row, their exposed end at the tongue side will be tightened with a starting lock nut 70. When the first row of the strips is established the second row will join in a way that the exposed mail threads of the male end 62 of the fasteners 60 at the tongue will be tightened to the heads of the female ends 64 of the fasteners 60 exposed in the bores of the first row. Every row will be fastened to the neighboring row one after the other until the finishing wall is approached, and at this time the distance between the last complete row and the finishing wall is measured.

If the distance is almost ½ inch from the finishing wall the last fasteners are tightened and the process is ended. The shoe moldings are the final pieces to be installed. If the distance is more than ½ inch then the last row has to be cut along the length of the board to become a partial row, and ½ inch must be subtracted from the total distance measured between the last complete row and the finishing wall. The result of this subtraction is the size of the partial row; this way ½ inch gap to the finishing wall is kept. In order to finish and fasten this partial row the hole making sequence must be kept the same way, and the parts needed to finish the partial end row are the free-headed length adjuster screws, the end cap nuts and the measuring nut.

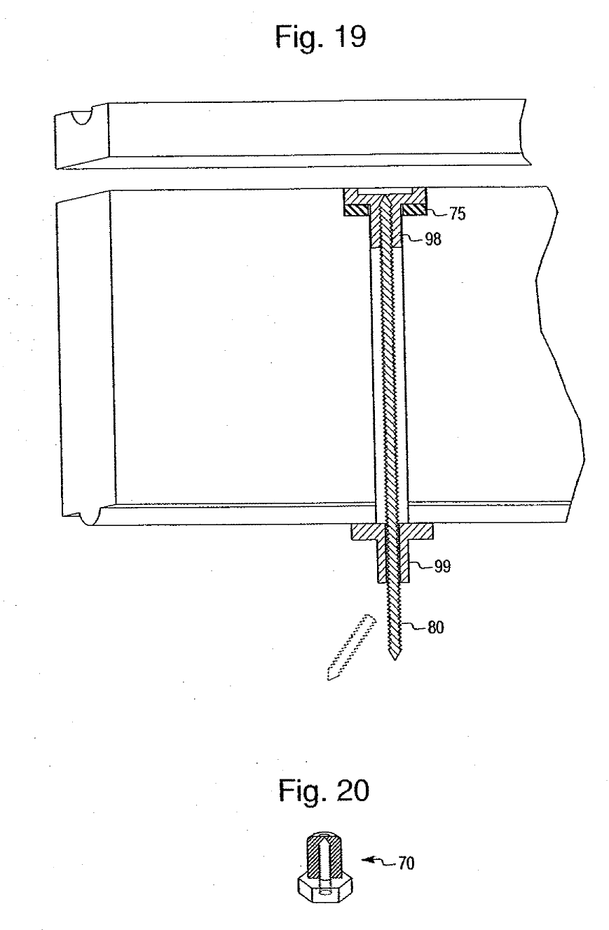

When the free-head length adjuster screw 80 is cut and sized properly, it is joined with the end cap nut 98, and this combination 80, 98 is inserted in the bores of the partial row and is tightened to the rest of the rows. To achieve the correct size, first the free head adjuster screw 80 is tightened to the end cap nut 98. Next, the combination of the free head length adjuster screw 80 and the end cap nut 98 is inserted in the bore of the partial row wood strip as shown in FIG. 19, and the measuring nut 99 is tightened to the other end of the length adjuster screw 80 as shown in FIG. 19. With the depth measuring nut 99 in place, the excess amount of thread coming out of the measuring nut 99 is removed (see tip portion shown in dotted lines in FIG. 19). The measuring nut 99 at the other end is unscrewed and taken out. Now the partial wood strips are inserted and synchronized hole to hole with the neighboring row and the combination of free head adjuster screw 80 and the end cap nut 98 is tightened to the fasteners in the neighboring row. Installing the shoe moldings and hiding the gaps completes the process.

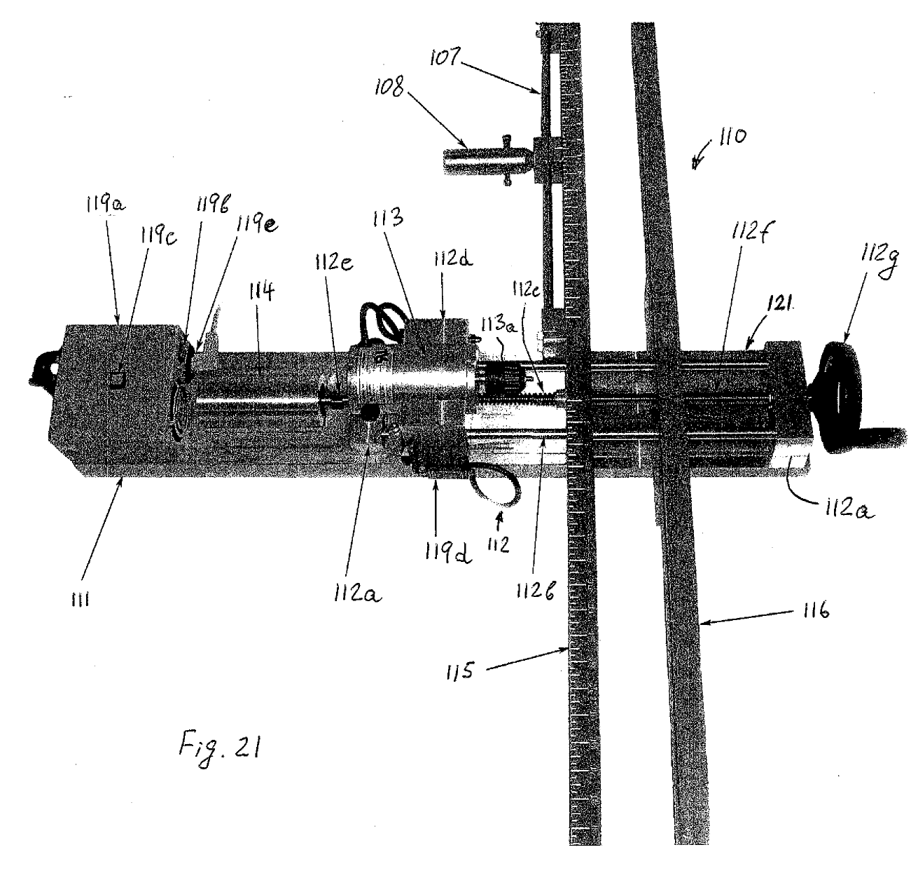

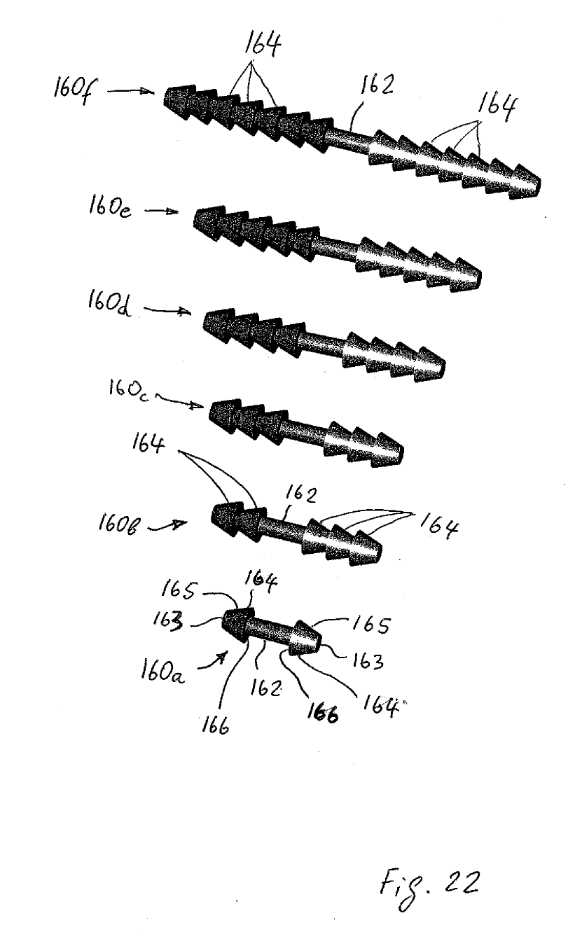

FIG. 21 of the drawings depicts a second exemplary embodiment of a hole making device of the present invention generally depicted by the reference numeral 110.

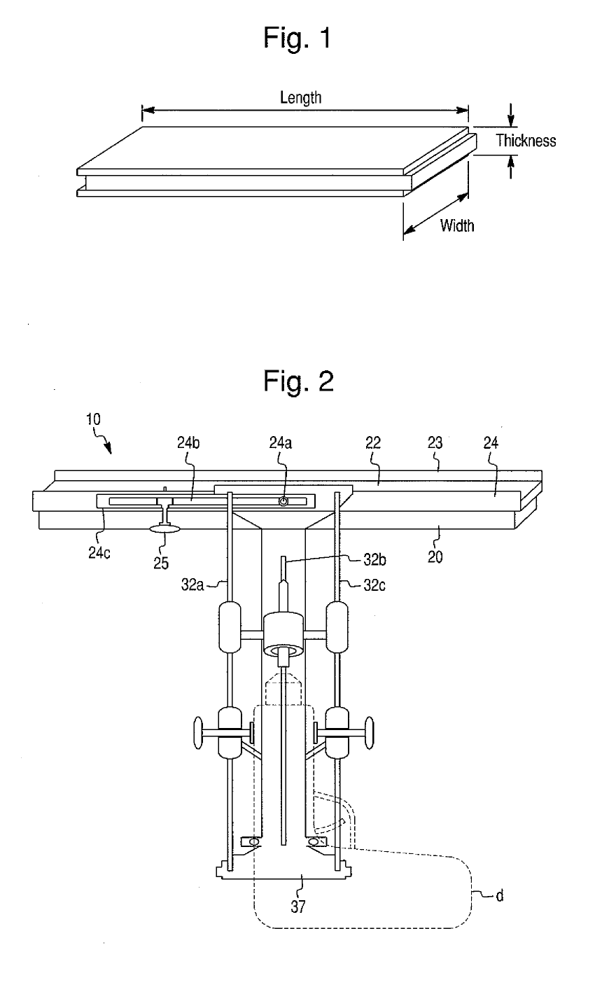

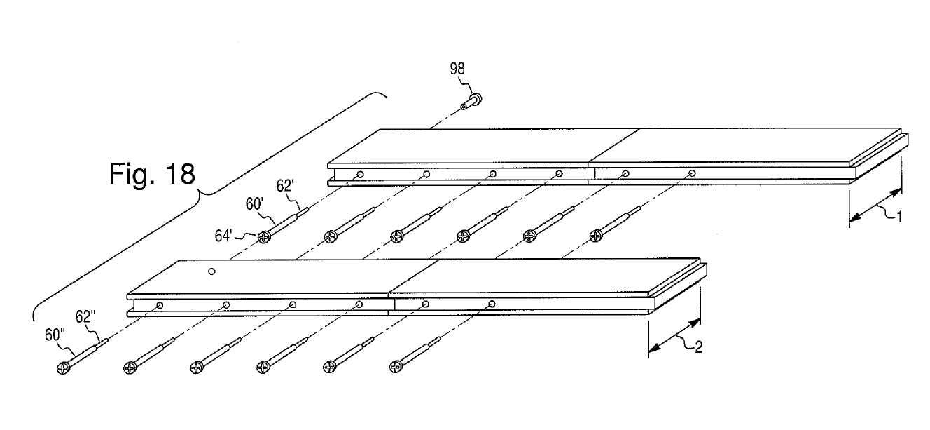

Components, which are unchanged from the first exemplary embodiment of the present invention, are labeled with the same reference characters. Components, which function in the same way as in the first exemplary embodiment of the present invention depicted in FIGS. 1-4 and 18, are sometimes depicted without being described in detail since similarities between the corresponding parts in the two embodiments will be readily perceived by the reader.

The hole making device 110 includes the components of and applies the same principals described for the hole making device 10 according to the first exemplary embodiment of the present invention, and is a fully automated device. Specifically, the hole making device 110 comprises a frame member (chasy) 111 supporting all the components of the hole making device 110, a linear guide assembly 112, a drill motor 113 with a chuck 113a mounted at a distal end thereof, an actuator motor 114, a fixed wood guiding sidewall 115, and an adjustable wood guiding sidewall 116. The fixed and adjustable wood guiding sidewalls 115 and 116 define a wood guiding channel 117 provided for supporting the solid wood strip therein. The adjustable sidewall 116 of the wood guiding channel 117 is slidably mounted on the linear guide assembly 112 to accommodate incoming hardwood strips with different widths. The fixed sidewall 115 of the wood guiding channel 117 contains a hole similar to the elongated side window 24b and the central hole 24a in the left side wall 24 of the hole making device 10, as shown in FIGS. 2 and 3.

The linear guide assembly 112 includes two end bases 112a which are located at two opposite polls of two stainless steel guiding rods 112b, a right hand acme guide screw 112c, a motor mount 112d, and an actuator coupling nut 112e. The hole making device 110 further comprises a channel jaw adjusting assembly 121 that includes an adjusting acme lead screw 112f, and a jaw adjusting crank handle 112g connected to a distal end of the adjusting lead screw 112f for adjusting position of the adjustable wood guiding sidewall 116 relative to the fixed wood guiding sidewall 115, i.e. a width of the wood guiding channel 117 according to the width of the wood strip 1. In turn, the motor mount 112d includes one acme nut (not shown) and two leaner bushings (not shown) holding the drill motor 113 for sliding the drill motor 113 back and forth on the guiding rods 112b of the leaner guide assembly 112. The guiding rods 112b connect the two polls of the guide and the motor mount 112d and the leaner bearings slide on them. The night hand acme guide screw 112c has one end passing through one of the end bases 112a and connected to the actuator motor 114, and the other end laying on a bushing inside a base of the fixed wood guiding channel 115. It also passes through the acme nut inside the motor mount 112d so that when the actuator motor 114 turns the guide screw 112c, the motor mount 112d slides forward and backward. The actuator coupling nut 112e connects and couples an output shaft of the actuator motor 114 to the acme guide screw 112c of the leaner guide assembly 112.

The lead screw 112f has one end laying on a bushing inside the base of the fixed wood guiding channel 115 and the other end passing through the opposite end base 112a of the leaner guide assembly 112. The lead screw 112f also passes through the acme nut inside the base of the adjustable wood guiding channel 116. Preferably, the lead screw 112f is a ½ acme lead screw engaging a complementary ½ acme nut of the adjustable wood guiding channel 116. The crank handle 112g is, preferably, a 3½″ jaw adjusting crank handle connected to the distal end of the ½″ lead screw 112f. By turning the crank handle 112g, the position of the adjustable wood guiding channel 116 can be adjusted.

The hole making device 110 further includes a ruler assembly 117, a hole synchronizing device 118 and an electronic control system 119. The ruler assembly 117 is consisted of two ⅜″ stainless steel rods and two end connectors which are mounted on the side of the fixed wood guiding channel 115. The hole synchronizing device 118 is consisted of ¼″ shaft, ¾″ cylinder, two wing nuts, a medium tension spring, a position holder nut and an end cap. The hole synchronizing device 118 is mounted on the ruler assembly 117 for synchronizing and measuring the distance of the holes created in the solid hardwood strips 1. The electronic control system 119 includes the following components: a power supply 119a providing electric power for the electronic components and motors, relaying order the start, reversing and stopping of motor and actuator when and where needed and converting 120 AC to 12 V DC voltage; an On/off switch 119b that turns the power supply on and off, a start pushbutton switch 119c that turns the motor and actuator on by connecting relay contacts; limit switches 119d for starting and reversing the direction of actuator's rotation and stopping the whole process where they hit the limit, and a power entry module and cables 119e that transfer electricity to the entire unit. The electronic control system 119 of the hole making device 110 instructs the actuator motor 114 to push the drill motor and chuck assembly 113 towards the fixed wood guiding channel 115 to drill a hole in the hardwood strip 1 and then reverse the process by changing the rotation of the actuator motor 114 and pulling back the drill motor 113 to an initial (first) position.

Moreover, the hole making device 110 is provided with a four-legged stand assembly (not shown) to provide efficient height when the hole making device 110 is set up for work. This assembly has two U-shape parts which are bolted to opposite polls of the frame member 111. Two legs are connected to each U-shape part by a specific angel providing a four legged assembly for the hole making device 110 to stand on.

It should be understood that the hole making device 110 may function like a typical drill press or other assembly designed to form lateral holes in the wood member at desired positions.

Fasteners for interconnecting the solid hardwood strips 1 will now be described with reference to FIG. 22. The fasteners and their components are designed to fasten the hardwood strips in a very versatile and practical way so that any type of floor can be covered by solid hardwood.

Anchoring (or main) fasteners 160a-160f shown in FIG. 22 are primarily used to fasten (or anchor) the strips of wood together and are designed in different lengths for different applications and/or to accommodate the solid hardwood strips of different widths. For example, the shortest fastener 160a is a 1.00″ long transitional fastener for transition moldings and trims. The fastener 160b is a 1.75″ end fastener for a partial hardwood. The fastener 160c is a 2.00″ fastener for solid hardwood strips 2.25″ and 2.50″ wide. The fastener 160d is a 2.50″ fastener for solid hardwood strips 3.00″ and 3.25″ wide. The fastener 160e is a 3.00″ fastener for solid hardwood strips 3.50″ and 4.00″ wide. The fastener 160f is a 4.00″ fastener for solid hardwood strips 5.00″, 6.00″ and 7.00″ wide.

Each of the fasteners 160a-160f includes an elongated, substantially cylindrical shank 162 having opposite distal ends 163 each provided with at least one radially projecting, substantially annular tooth (or rib) 164 that is generally in the shape of a sawtooth in a cross-section. For example, the shortest fastener 160a has only one annular tooth 164, while the fasteners 160b-160f are provided with a plurality of the annular teeth 164. As shown in FIG. 22, the annular teeth 164 are formed on an outer peripheral surface of the shank 162 adjacent to the corresponding distal ends 163 thereof. Preferably, the teeth 164 at each distal end 163 of the shank 162 are substantially identical in shape and dimensions and are equidistantly axially spaced along the shank 162. Moreover, the fasteners of the present invention may have different number of annular teeth 164 on opposite distal ends thereof. For example, the fastener 160b is illustrated as having two annular teeth 164 at the left distal end and three annular teeth 164 at the right distal end thereof. Furthermore, an inclined side 165 of the annular tooth (or teeth) 164 faces forwardly toward the adjacent distal end of the shank 162 and away from the annular tooth (or teeth) 164 formed on the opposite end of the shank 162, while their rear sides 166 are substantially normal to the outer peripheral surface of the shank 162.

The opposite distal ends of the fasteners 160a-160f are designed to be matingly received in bore holes in the solid hardwood strips 1 produced by the hole making device 110. It should be understood that an outer diameter of the annular teeth 164 is slightly larger than an inner diameter of the bore holes produced by the hole making device 110 so that the annular teeth 164 snugly engage an inner cylindrical surface of the bore holes when the fasteners 160a-160f are inserted thereinto.

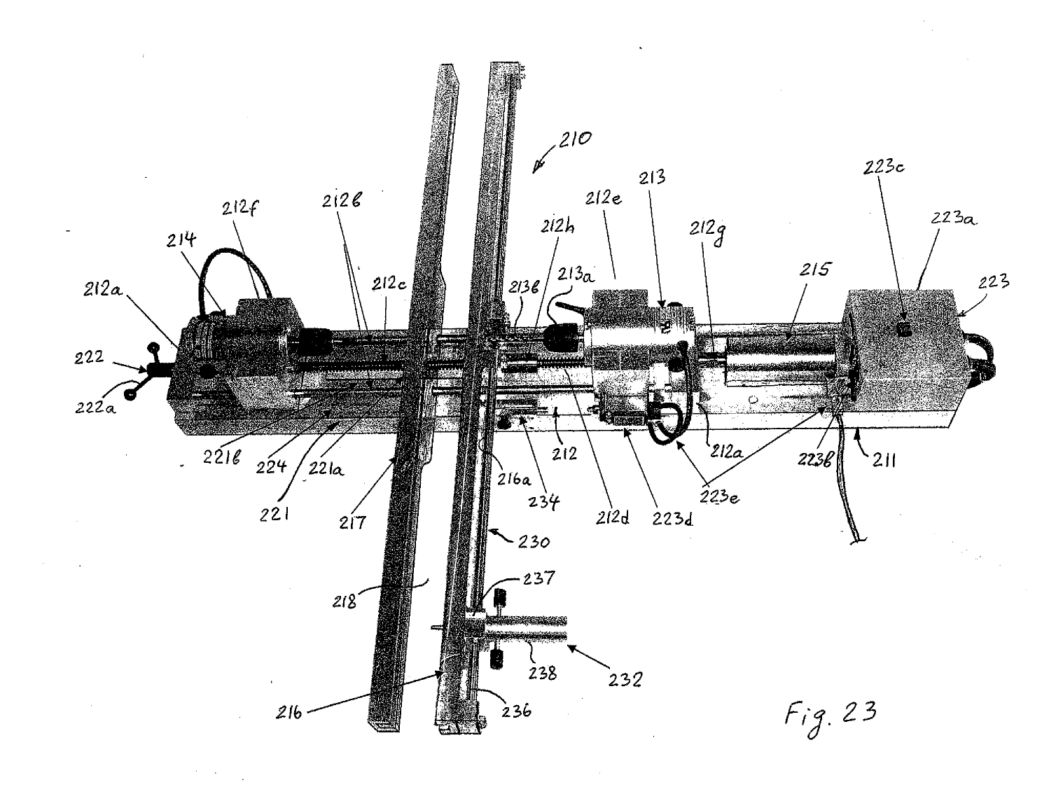

FIG. 23 of the drawings depicts a third exemplary embodiment of a hole making device of the present invention generally depicted by the reference numeral 210.

Components, which are unchanged from the first and second exemplary embodiments of the present invention, are labeled with the same reference characters. Components, which function in the same way as in the first and second exemplary embodiments of the present invention depicted in FIGS. 1-4, 18 and 21, are sometimes depicted without being described in detail since similarities between the corresponding parts in the two embodiments will be readily perceived by the reader.

The hole making device 210 includes the components of and applies the same principals described for the hole making devices 10 and 110 according to the first and second exemplary embodiments of the present invention, and is a fully automated device. Specifically, the hole making device 210 comprises a frame member (chasy) 211 supporting all the components of the hole making device 210, a leaner guide assembly 212, a leading (or first) drill motor 213 with a first drill chuck 213a mounted thereon, a lagging (or second) drill motor 214 with a second drill chuck 214a mounted thereon, an actuator motor 215, a fixed (or first) wood guiding sidewall 216, and an adjustable (or second) wood guiding sidewall 217. The first drill chuck 213a is driven by the first drill motor 213 for drilling a hole in the solid wood strip with a drill bit 213b secured in the first drill chuck 213a. Similarly, the second drill chuck 214a is driven by the second drill motor 214 for drilling a hole in the solid wood strip opposite to the hole in the solid wood strip drilled with the first drill chuck 213a. Preferably, a central axis of the first chuck 213a is coaxial with a central axis of the second chuck 214a.

The fixed wood guiding sidewall 216 is a stationary jaw which holds the wood strip to be drilled into. In other words, the fixed wood guiding sidewall 216 is non-movably mounted to the linear guide assembly 212 and the frame member 211. This part can be separated from the frame member 211 for the ease of transportation. The adjustable wood guiding sidewall (or jaw) 217 is a moving jaw that adjusts to the width of the wood strip and holds it against stationary jaw 216. The adjustable wood guiding channel 217 is slidably mounted to the linear guide assembly 212 and the frame member 211, and can also be removed from the frame member 211 for the ease of transportation.

The fixed and adjustable wood guiding sidewalls 216 and 217 define a wood guiding channel 218 provided for supporting the solid wood strip therein. The fixed sidewall 216 of the wood guiding channel 218 has a hole 216a similar to the elongated side window 24b in the left side wall 24 of the hole making device 10, as shown in FIGS. 2 and 3. Similarly, the adjustable wood guiding sidewall 217 has a hole 217a similar to the elongated side window 24b in the left side wall 24 of the hole making device 10, as shown in FIGS. 2 and 3. The holes 216a and 217a are provided for receiving drill bits secured in the first and second drill chucks 213a and 214a, respectively, therethrough. Preferably, each of the fixed and adjustable wood guiding sidewalls 216 and 217 has a U-shaped cross section (as shown in FIG. 23) for engaging opposite sides (in the direction of width) of the solid hardwood strip 1 in order to securely hold the solid hardwood strip 1 between the fixed and adjustable wood guiding sidewalls 216 and 217, i.e. in the wood guiding channel 218.

The linear guide assembly 212 includes two end bases 212a which are located at two opposite polls of two stainless steel guiding rods 212b, a left hand acme guide screw (or first guide screw) 212c, a right hand acme guide screw (or second guide screw) 212d, a leading (or first) motor mount 212e, a lagging (or second) motor mount 212f, an actuator coupling nut 212g, and an engage/disengage coupling nut 212h. The leading motor mount 212e includes one right hand acme nut (not shown) and two leaner bushings (not shown) to hold the leading motor 213 and the first drill chuck 213a and slide them back and forth on the linear guide assembly 212. In turn, the lagging motor mount 212f includes one left hand acme nut (not shown) and two linear bushings (not shown) to hold the lagging motor 214 and the second drill chuck 214a and slide them back and fort on the linear guide assembly 212. The guiding rods 212b connect the two polls of the end bases 212a and the leading and lagging motor mounts 212e, 212f and the leaner bearings slide on them. In other words, the first and second drill motors 213 and 214 are slidably mounted on the guiding rods 212b of the linear guide assembly 212. The actuator motor 215 is provided for selectively moving the first and second drill motors 213 and 214 along the guiding rods 212b of the linear guide assembly 212 to and away from each other and the wood guiding channel 218.

The first guide screw 212c has one end passing through one of the end bases 212a and connected to the actuator motor 215 via actuator coupling nut, and the other end thereof is connected to the engage/disengage coupling nut 212h. It also passes through the acme nut inside the leading motor mount 212e so that when the actuator motor 215 turns the first guide screw 212c, the first motor mount 212e slides forward and backward. Similarly, the second guide screw 212d has one end connected to the engage/disengage coupling nut 212h and the other end thereof which is a tail stock that passes through the other end base 212a of the linear guide assembly 212. It also passes through the acme nut of the lagging motor mount 212f so that when the actuator motor 215 turns the second guide screw 212d, the second motor mount 212f slides back and forth.

The actuator coupling nut 212g connects and couples an output shaft of the actuator motor 215 to the first guide screw 212c of the linear guide assembly 212. The engage/disengage coupling nut 212h is located between the first and second acme lead screws 212c and 212d of the two leading and lagging motor mounts 212e and 212f. When these lead screws 212c and 212d are engaged by the nut they act as one lead screw pushing the two motors 213 and 214 towards each other or away from each other. When these screws 212c and 212d are disengaged by the nut, they act as separate entities allowing adjustment of distance between the motors 213 and 214 and the wood guiding channel 216.

The leading motor and chuck 213 is a 120 v, 60 Hz, 2500 rpm, 1 hp AC motor which is armed with a ⅜″ keyless chuck. Because this motor is adjusted first and leads the hole making device 210 in accordance with the depth of the holes, it is called a leading motor. The lagging motor and chuck 214 is a 120 v, 60 Hz, 2500 rpm, ½ hp AC motor which is armed with a ⅜″ keyless chuck. Because this motor follows the adjustments made on the leading motor 213, it is called a lagging motor. The actuator motor 215 is 12 v, 900 rpm, 16 amp DC motor which couples with the leaner guide and pushes and pulls the motors 213 and 214 on the guide rods 212b.

The hole making device 210 further includes a ruler assembly 230, a hole synchronizing device 232 and a depth measuring device 234. The ruler assembly 230 includes two ⅜″ stainless steel ruler rods 236 extending parallel to the first fixed wood 20 guiding sidewall 216, two end connectors and two left and right 0 to 18″ register rulers which are mounted on the side of the fixed wood guiding sidewall 216, and a sliding pointer block 237 slidably movable along the ruler rods 236. The hole synchronizing device 232 includes a ¾″ cylinder 238 fixed to the sliding pointer block 237, a ¼″ shaft 240 movable in the cylinder 238, two wing nuts, medium tension spring, position holder nut and end cap. The hole synchronizing device 232 is mounted on the ruler assembly 230 for synchronizing and measuring the distance of the holes drilled in the wood strip. The depth measuring device 234 includes a housing, a measuring ruler, a tail stock and a tightening knob. Because the width of the wood planks (strips) varies, the length of the corresponding fasteners 160a-160f (shown in FIG. 22) also varies. For this reason, the depth measuring device 220 allows the depth of the holes to be created in accordance to the width of the wood planks being installed and a length of the corresponding fasteners 160a-160f needed.

The hole making device 210 further comprises a channel jaw adjusting assembly 221 that allows the wood guiding channel to be adjusted according to the width of the wood planks 1 passing through the channel, an interchangeable jaw and motor adjusting handle 222, and an electronic control system 223. The channel jaw adjusting assembly 221 includes the following components: two end bases located under the frame member 211 beneath the leaner guide assembly 212 and holding a ½″ acme lead screw; a right hand acme nut 221a incorporated in a base of the adjustable wood guiding sidewall 217 for sliding the jaw of the channel back and forth; and a right hand adjusting screw 221b held by the two bases of the jaw adjusting assembly 221 so that one end thereof sits in a bushing incorporated in one of the end bases, and the other end (in the form of a tail stock) passes through the other end base of the assembly. The interchangeable jaw and motor adjusting handle 222 has a mobile handle 222a which can be interchanged between the channel jaw adjusting tail shaft and lagging motor's lead screw tail shaft. If the handle 222a is mounted on the upper shaft, it can be turned to adjust the lagging motor 214 and position of the adjustable wood guiding sidewall 217, if it is mounted on the lower shaft it can be turned to adjust the jaw between the fixed wood guiding sidewall 216 and the adjustable wood guiding sidewall 217.

The electronic control system 223 includes the following components: a power supply 223a providing electric power for the electronic components and motors, relaying order the start, reversing and stopping of motor and actuator when and where needed and converting 120 AC to 12 V DC voltage; an On/off switch 223b that turns the power supply on and off, a start pushbutton switch 223c that turns the motor and actuator on by connecting relay contacts; limit switches 223d for starting and reversing the direction of actuator's rotation and stopping the whole process where they hit the limit; and a power entry module and cables 223e that transfer electricity to the entire unit. The electronic control system 223 of the hole making device 210 instructs the actuator motor 215 to push the motors and chuck assemblies 213, 214 towards the fixed wood guiding channel 216 to drill two holes in the opposite sides of the hardwood strip 1 and then reverse the process by changing the rotation of the actuator motor 215 and pulling back the drill motors 213, 214 to an initial (first) position.

The hole making device 210 further includes a wood selecting measuring ruler 224 located on the frame member 211 near the lagging motor 214 which provides accurate distance between the lagging motor 214 and the adjustable wood guiding sidewall 217 allowing different wood strip width to enter the channel to be correctly drilled. Moreover, the hole making device 210 is provided with a four-legged stand assembly (not shown) to provide efficient height when the hole making device 210 is set up for work. This assembly has two U-shape parts which are bolted to opposite polls of the frame member 211. Two legs are connected to each U-shape part by a specific angel providing a four legged assembly for the hole making device 210 to stand on.

Therefore, the hole making device 210 requires a completely modified fastener system. In this system the fasteners 160a-160f are not male I female fasteners and the holes in the solid hardwood strips 1 are not drilled all the way through, instead the depth of the holes are controlled by the depth measuring device 220 so the fasteners 160a-160f can be inserted into a certain depth in the solid hardwood strips 1. The hole making device 210 is armed with two powerful drill motors 213 and 214 facing each other across the wood guiding channel drilling two holes simultaneously across the opposite sides of the wood planks 1. This system not only speeds up the installation process five times than the previous systems, hut also improves the life of the drill bits unexpectedly.

Due to the differences in the room size, shape angle, framing, permanently stationed objects and floor environment, this invention was designed and equipped with very versatile parts to enable one to install solid hardwood efficiently, accurately, and easily.

From the foregoing description and associated drawings, it will be apparent to those of skill in the art that the present invention enables one to bring the beauty and durability of solid hardwood to major commercial concrete based areas such as office spaces, restaurants, high-rises, condominiums and residential basements.

By introducing this invention, one can save more natural resources or at least in the long run bring the tree cutting time and tree regeneration time to equilibrium. When installed this product is floating on a spongy foam backed moisture barrier sheet which makes the solid hardwood easier to stand on for long periods (spinal cord friendly) and provides impact resistance from falling objects.

With this invention, one also does not have to worry about the same deficiencies presented by engineered hardwood, such as the warping, bowing, expansion, contraction, its short life and its detachment from concrete caused by temperature and moisture.

While the foregoing invention has been shown and described with reference to a preferred embodiment, it will be understood that various changes in form and detail may be made to the examples shown and described without departing from the spirit and scope of the invention.

What is claimed is:

1. A floor installation system including a hole making device for drilling bore holes in a solid wood strip, said hole making device comprising:
a linear guide assembly including at least one guiding rod;
a first drill motor slidably mounted on said at least one guiding rod of said linear guide assembly, said first drill motor provided with a first drill chuck driven by said first drill motor for drilling a hole in said solid wood strip;
a first wood guiding sidewall non-movably mounted to said linear guide assembly and a second wood guiding sidewall mounted to said linear guide assembly, said first and second wood guiding sidewalls defining a wood guiding channel therebetween for supporting said solid wood strip; and
an actuator motor provided for selectively moving said first drill motor along said at least one guiding rod of said linear guide assembly to and away from said wood guiding channel.

2. The floor installation system as defined in claim 1, wherein said first wood guiding sidewall has a hole provided for receiving a drill bit of said first drill chuck therethrough.

3. The floor installation system as defined in claim 1, wherein said linear guide assembly of said hole making device further includes a first guide screw operatively coupled to said first drill motor and rotatably driven by said actuator motor so that rotation of said first guide screw causes said first drill motor to move along said at least one guiding rod of said linear guide assembly to and away from said wood guiding channel.

4. The floor installation system as defined in claim 3, wherein said linear guide assembly of said hole making device further includes a second drill motor slidably mounted on said at least one guiding rod of said linear guide assembly so that said wood guiding channel is disposed between said first and second drill motors, said second drill motor provided with a second drill chuck facing said drill chuck and driven by said second drill motor for drilling a hole in said solid wood strip; and
wherein said actuator motor is provided for selectively moving said second drill motor along said at least one guiding rod of said linear guide assembly to and away from said wood guiding channel.

5. The floor installation system as defined in claim 4, wherein said linear guide assembly of said hole making device further includes a second guide screw drivingly coupled to said first guide screw, operatively coupled to said second drill motor and rotatably driven by said actuator motor so that rotation of said second guide screw causes said second drill motor to move along said at least one guiding rod of said linear guide assembly to and away from said wood guiding channel.

6. The floor installation system as defined in claim 4, wherein said second wood guiding sidewall has a hole provided for receiving a drill bit of said second drill chuck therethrough.

7. The floor installation system as defined in claim 1, wherein a central axis of said second chuck is coaxial with a central axis of said second chuck.

8. The floor installation system as defined in claim 1, wherein said second wood guiding sidewall is movably mounted to said linear guide assembly for adjusting a width of said wood guiding channel; and wherein said hole making device further comprises a channel jaw adjusting assembly that allows a width of said wood guiding channel to be adjusted according to the width of said wood strip.

9. The floor installation system as defined in claim 8, wherein said channel jaw adjusting assembly includes an adjusting screw a proximal end of which is operatively coupled to said second wood guiding sidewall so that rotation of said adjusting screw causes said second wood guiding sidewall to move to and away from said fixed first fixed wood guiding sidewall for adjusting position of said first fixed wood guiding sidewall.

10. The floor installation system as defined in claim 9, wherein said linear guide assembly of said hole making device further a jaw adjusting crank handle connected to a distal end of said adjusting screw for adjusting position of the second wood guiding sidewall.

11. The floor installation system as defined in claim 1, wherein said linear guide assembly of said hole making device further includes two end bases located at two opposite ends of said at least one guiding rod.

12. The floor installation system as defined in claim 1, wherein said hole making device further comprises a ruler assembly and a hole synchronizing device for synchronizing and measuring the distance of holes drilled in said solid wood strip;
said ruler assembly includes a ruler rod extending parallel to said first fixed wood guiding sidewall and a sliding pointer block slidably movable along said ruler rod.

13. The floor installation system as defined in claim 12, wherein said hole synchronizing device includes a cylinder fixed to said sliding pointer block, a shaft movable in said cylinder.

14. The floor installation system as defined in claim 1, wherein said hole making device further comprises a depth measuring device for measuring a depth of said hole drilled in said solid wood strip.

15. The floor installation system as defined in claim 1, wherein said hole making device further comprises an electronic control system including a power supply, an On/off switch that turns the power supply on and off, and a start pushbutton switch for actuating said first drill motor and said actuator motor.

16. The floor installation system as defined in claim 1, wherein each of said first and second wood guiding sidewalls has a U-shaped cross section for engaging opposite sides of said solid wood strip in the direction of width thereof.
